(19) United States
(12) Patent Application Publication
(10) Pub. No.: US 2010/0318229 A1
(43) Pub. Date: Dec. 16, 2010

(54) Field device and method for processing at least one measured variable in a field device

(76) Inventors: Andreas Kaszkin, Kandel (DE); Wolfgang Stiehl, Worth (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/308,286

(22) PCT Filed: Jun. 14, 2007
(86) PCT No.: PCT/EP2007/055900

§ 371 Date: Jun. 11, 2010

(30) Foreign Application Priority Data
Jun. 14, 2006 (DE) 10 2006 028 006.7

(51) Int. Cl. G05D 7/00

(52) U.S. Cl. 700/282

(57) ABSTRACT

A field device, which, as part of an automation system, carries out device-specific functions in the automation of the operational sequence of a system, detects and processes at least one measured variable from the system and has a communication interface for communication with the automation system. In order to make possible measurements signal filtering, the measured variable detected by the field device from the system is filtered in a signal filter, whose filter characteristic is variable and is matched to different predetermined filter characteristics as a function of event information from the operation sequence of the system obtained via the communication interface.

### CROSS REFERENCE TO RELATED APPLICATIONS

This application is the US National Stage of International Application No. PCT/EP2007/055900 filed Jun. 14, 2007, and claims the benefit thereof. The International Application claims the benefits of German application No. 10 2006 028 006.7 DE filed Jun. 14, 2006, both of the applications are incorporated by reference herein in their entirety.

### FIELD OF INVENTION

The invention relates to a field device and to a method for processing at least one measured variable in a field device.

### BACKGROUND OF INVENTION

In automation systems for technical or industrial installations, e.g. the process industry, production and manufacturing industry, building technology or network technology, spatially-distributed, local field devices (process devices) in the relevant installation perform predetermined functions within the framework of the automation of the installation and in doing so exchange process, installation and/or device-relevant information, but always with higher-ranking components of the automation system, especially its process control system or engineering system. The field devices include items such as transducers for pressure, temperature, throughflow rate, fill level etc., analysis devices for gas or fluid analysis, weighing systems, actuators, position controllers for valves, other decentralized closed-loop controllers and frequency converters for electric motor drives. For exchange of the data within the automation system the field devices are connected in the local peripheral area, if necessary together with decentralized open and closed loop control and operating and monitoring, via field buses or other communication paths, with different field buses being linked to each other via bus couplers. The field buses can in their turn be connected via controllers, such as Programmable Logic Controllers for example, to a central installation bus, to which the process control or engineering system, i.e. the central open and closed-loop control, operation and maintenance is connected.

Measured variables detected by the field devices, especially by transducers, in the installation are generally filtered, to free them from frequency components and disturbances of no interest (measured variable (e.g. pressure) and the electrical measuring signal derived from it is used synonymously here for the sake of simplicity). In the signal filters currently used for the purpose the filter characteristic is usually permanently set so that it remains unchanged during the entire operational sequence of the installation. The setting of the limit frequency of a lowpass filter or the filter width of a mean value filter for example thus represents a compromise between the speed of reaction to signal changes and the measurement accuracy demanded. The use of adaptive signal filters is also known, in which the filter characteristic is modified as a function of the signal waveform of the filtered signal.

### SUMMARY OF INVENTION

An object of the invention is to make possible rapid and precise measuring signal filtering with simple means.

In accordance with the invention the object is achieved by the field device or by the method according to the independent claims.

Advantageous developments of the inventive field device or method are to be found in the dependent claims.

The subject matter of the invention is thus a field device for performing device-specific functions within the framework of automating the operational sequence of an installation, in which the field device, together with further spatially-distributed field devices, is connected via a communication system to a process control system,

with a communication interface for connection of the field device to the communication system,

with a control device for control of the device-specific functions as well as the communication of data via the communication interface,

with means for detecting and processing at least one measured variable from the installation, with the means containing a signal filter with modifiable filter characteristic, and

with a filter adaptation device able to be activated by the control device for adapting the filter characteristic to different predetermined filter characteristics as a function of event information from the operational sequence of the installation obtained via the communication interface,

or a

method for processing at least one measured variable in a field device of an automation system, with the field device performing device-specific functions within the framework of automation of the operational sequence of an installation and exchanging information via a communication interface with the automation system and with the measured variable detected by the field device from the installation being filtered in a signal filter, of which the filter characteristic is able to be modified and adapted to different predetermined filter characteristics, depending on event information obtained via the communication interface from the operational sequence of the installation.

An exact or rapid measurement can be improved by the dynamic adaptation of the signal filtering being event-controlled directly from knowledge about the operational sequence of the installation. Such an event can for example be an increase in pressure in the installation, with the increase in pressure being initiated for example by a control signal for opening a valve in the installation. This control signal for the valve precedes the actual pressure increase and is used for example for adapting the filter characteristic of the signal filtering in a pressure measurement transducer to the subsequent increase in pressure with the transitory pressure fluctuations resulting from this. If for example the pressure signal in the pressure transducer is lowpass-filtered then preferably, as a reaction to the event information obtained (said control signal for the valve in this case), the limit frequency of the signal filter is increased, so that the signal filter can follow the measuring signal more quickly. This is of advantage if pressure peaks are to be detected for example. By the limit frequency being modified within a predetermined time from the higher value back to the lower value, the output signal of the signal filter is brought back very quickly to the mean value of the measuring signal which reflects the pressure exactly. The change in the limit frequency follows a predetermined time function, for example exp −t/τ or exp −(t/τ)², with t being the time and τ a predetermined time constant for which parameters can be specified for example.

In the case of a mean value filtering, the filter width, i.e. the number of checkpoint values of the measuring signal included for mean value generation, is changed in a similar manner from a predetermined lower value to a predetermined higher value.

In addition the filter characteristic can also be modifiable in respect of the filter type, e.g. Bessel or Butterworth filter and/or the filter order.

### BRIEF DESCRIPTION OF THE DRAWINGS

For further explanation of the invention reference is made below to the figures of the drawing; the individual figures show:

FIG. 1 a block diagram of an automation system,

FIG. 2 an example of the field device, and

FIG. 3 an example of the filtering of a measured variable detected by the field device.

### DETAILED DESCRIPTION OF INVENTION

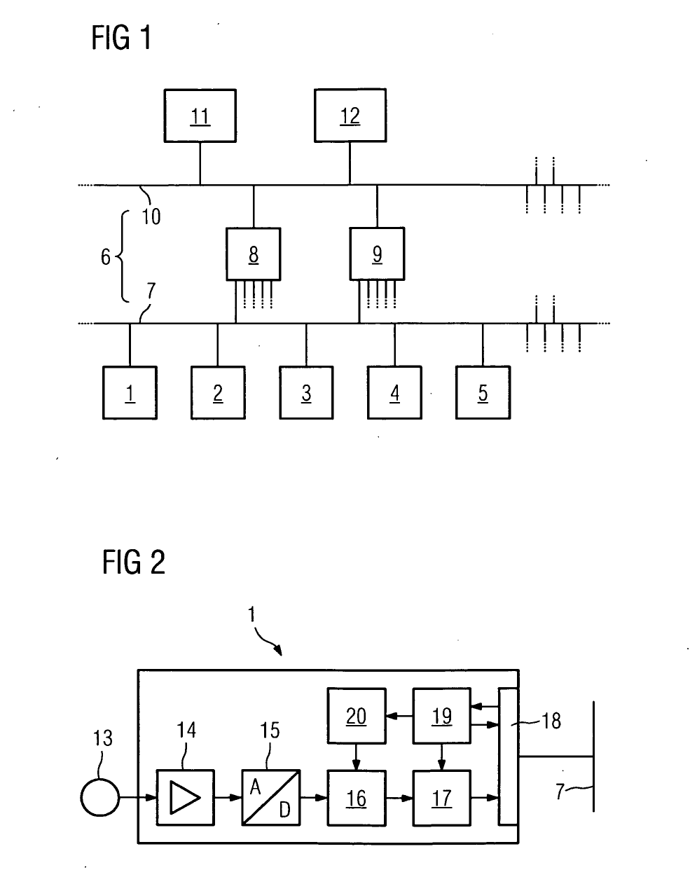

FIG. 1 shows, in a simplified schematic diagram, an example of an automation system with field devices 1 to 5, which in a process subject to closed-loop and/or open-loop control, or in an installation in which such a process is running, detect predetermined closed-loop or open-loop control functions and in doing so exchange process, function and/or device-relevant data with the process automation system over a network 6. To this end the field devices 1 to 5 are connected via a field bus 7, e.g. in accordance with the PROFIBUS standard, as a component of the network 6 to automation devices 8 and 9, e.g. Programmable Logic Controllers (PLC), which in their turn are connected via a central installation bus 10 to a higher-ranking closed-loop and open-loop control 11 and operation and monitoring 12. Such an automation system can basically feature a different number of automation systems in which the individual components of the automation system are arranged and communicate with each other over a network consisting of different communication paths.

At least a few of the field devices 1 to 5 are measuring transducers which detect and process the variables from the installation or the process. Other field devices, such as position controllers for example, can detect measured variables without the devices involved being measuring transducers.

FIG. 2 shows in a simplified schematic diagram an example for field device 1, which in this figure is a measuring transducer. This has a measured variable sensor 13, which detects a measured variable in the process or in the installation, e.g. a throughflow rate, and generates a corresponding measuring signal. The measuring signal passes through a measuring signal amplifier 14, an analog/digital converter 15 and a signal filter 16 with modifiable filter characteristics in turn, before being evaluated in an evaluation device 17 into a measured variable for process control. The field device 1 is connected via a communication interface 18 to the field bus 7, so that the measured variable can be transmitted to other components of the automation system. The evaluation of the measuring signal and communication via the communication interface 18 are controlled by a control device 19. In addition the control device 19 also controls a filter adaptation device 20 in order to adapt the filter characteristics to various predetermined filter characteristics as a function of the event information from the operational sequence of the installation received via the communication interface 18.

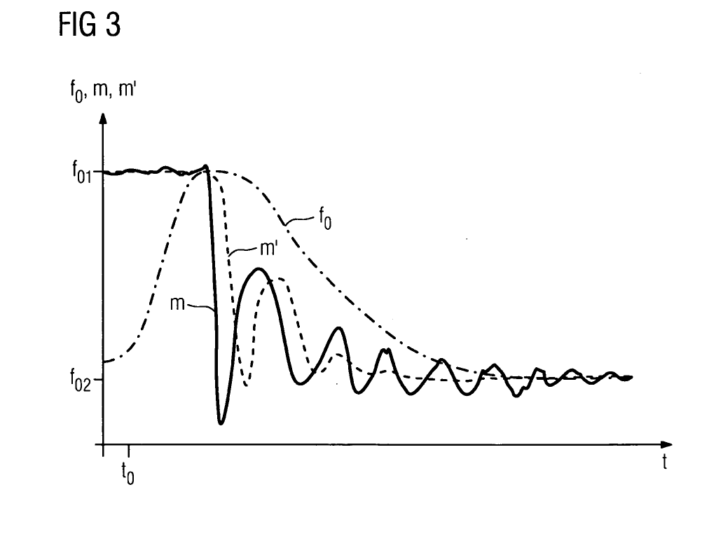

FIG. 3 shows a typical curve of the measured variable m, in this case a pressure in a fluid line of the installation for example. At a point in time t₀ an outlet valve in the line is opened by a corresponding control signal, so that the pressure drops suddenly. Because of the elasticity of the line system and of the components present within it, this results in oscillations in the measuring signal m, with the initially high oscillation amplitude falling over time. Further interference signals, such as vibrations coming from outside, are superimposed on the measuring signal m. In order to obtain the exact mean pressure value as quickly as possible which corresponds to the mean value of the measuring signal, the control signal for the outlet valve is transmitted as an event message to the field device 1. Subsequently the limit frequency f₀ of the signal filter 16, embodied here as a lowpass filter for example, is raised to a higher value f₀₁ and subsequently modified with a predetermined time function, here for example δ(t)=f₀₂[1+((f₀₁−f₀₂)/f₀₂)exp−(t/τ)²] to a predetermined lower value f₀₂. The result achieved thereby is that the output signal m′ of the signal filter 16 can initially follow the oscillations of the measuring signal m in order to then be brought very rapidly to the mean value of the measuring signal m.

1.-8. (canceled)

9. A field device for performing device-specific functions within an automation of an operational sequence of an installation, comprising:
a communication interface for connecting the field device to an communication system;
a control device for controlling the device-specific functions as well as a communication of data via the communication interface;
devices for detecting and processing a measured variable from the installation including a signal filter with a modifiable filter characteristic; and
a filter adaptation device able to be activated by the control device for adapting the filter characteristic to different predetermined filter characteristics as a function of the event information received from the operational sequences of the installation via the communication interface.

10. The field device as claimed in claim 9, wherein the field device and a plurality of spatially-distributed field devices are connected via the communication system to a process control system.

11. The field device as claimed in claim 9, wherein the filter characteristic is modified according to a filter parameter from the group consisting of filter type, filter order, limit frequency, mid frequency, bandwidth, and a combination thereof

12. The field device as claimed in claim 9, wherein the filter adaptation device changes the limit frequency of the signal filter embodied as a lowpass filter within a predetermined time from a predetermined higher value to a predetermined lower value after activation by the control device.

13. The field device as claimed in claim 11, wherein the filter adaptation device changes the limit frequency of the signal filter embodied as a lowpass filter within a predetermined time from a predetermined higher value to a predetermined lower value after activation by the control device.

14. The field device as claimed in claim 9, wherein the filter adaptation device changes the filter width of the signal filter embodied as a mean value filter within a predetermined time from a predetermined lower value to a predetermined higher value after activation by the control device.

15. The field device as claimed in claim 11, wherein the filter adaptation device changes the filter width of the signal filter embodied as a mean value filter within a predetermined time from a predetermined lower value to a predetermined higher value after activation by the control device.

16. The field device as claimed in claim 9, wherein the field device is a measuring transducer having a measured variable sensor which detects the measured variable in the process or in the installation and generates a corresponding measuring signal, the measuring signal passing through a measuring signal amplifier, an analog/digital converter and a signal filter with modifiable filter characteristics in turn before being evaluated in an evaluation device into a measured variable for process control.

17. A method for processing a measured variable in a field device of an automation system, comprising:
performing device-specific functions within an automation of an operational sequence of an installation by the field device;
exchanging information via a communication interface with the automation system by the field device; and
filtering the measured variable detected by the field device from the installation in a signal filter, wherein the filter characteristic of the signal filter is changed and adapted to different predetermined filter characteristics as a function of event information from the operational sequence of the installation received via the communication interface.

18. The method as claimed in claim 17, wherein the filter characteristic is modified according to a filter parameter from the group consisting of filter type, filter order, limit frequency, mid frequency, bandwidth, and a combination thereof

19. The method as claimed in claim 17, wherein the limit frequency of the signal filter embodied as a lowpass filter is changed within a predetermined time from a predetermined higher value to a predetermined lower value upon receipt of event information.

20. The method as claimed in claim 18, wherein the limit frequency of the signal filter embodied as a lowpass filter is changed within a predetermined time from a predetermined higher value to a predetermined lower value upon receipt of event information.

21. The method as claimed in claim 17, wherein the filter width of the signal filter embodied as a mean value filter is changed within a predetermined time from a predetermined lower value to a predetermined higher value upon receipt of event information.

22. The method as claimed in claim 18, wherein the filter width of the signal filter embodied as a mean value filter is changed within a predetermined time from a predetermined lower value to a predetermined higher value upon receipt of event information.
